(19) United States
(12) Patent Application Publication
(10) Pub. No.: US 2026/0270365 A1
(43) Pub. Date: Sep. 10, 2026

(54) COMMUNICATION APPARATUS, METHOD FOR CONTROLLING COMMUNICATION APPARATUS, AND STORAGE MEDIUM

(71) Applicant: CANON KABUSHIKI KAISHA, Tokyo (JP)

(72) Inventors: SOSUKE KAGAYA, Tokyo (JP); KENTA WATANABE, Kanagawa (JP)

(21) Appl. No.: 19/660,477

(22) Filed: Apr. 28, 2026

Related U.S. Application Data
(63) Continuation of application No. PCT/JP2024/039120, filed on Nov. 1, 2024.

(30) Foreign Application Priority Data
Nov. 10, 2023 (JP) 2023-192350

(51) Int. Cl. H04N 5/77

(52) U.S. Cl. CPC H04N 5/77

(57) ABSTRACT

A communication apparatus capable of communicating with an external apparatus performs, in a case where a file is generated in a first external apparatus, control to obtain the file from the first external apparatus and transfers, in a case where the file is obtained, the file to a second external apparatus. The communication apparatus controls, in a case where a first divided file is generated in the first external apparatus as a divided file generated in sequence by dividing continuous time-series data, whether to obtain the first divided file from the first external apparatus, in accordance with an obtainment status of a divided file from a start of the time-series data to a divided file prior to the first divided file.

### CROSS-REFERENCE TO RELATED APPLICATIONS

This application is a Continuation of International Patent Application No. PCT/JP2024/039120, filed November 1, 2024, which claims the benefit of Japanese Patent Application No. 2023-192350, filed November 10, 2023, both of which are hereby incorporated by reference herein in their entirety.

### BACKGROUND

### Field of the Technology

The present disclosure relates to a communication apparatus, a method for controlling a communication apparatus, and a storage medium.

### DESCRIPTION OF THE RELATED ART

A technique is known in which an image capturing apparatus such as a digital video camera is provided with a wireless communication function, and transmits, to an external apparatus, a moving image file recorded in such a manner that a moving image captured by the image capturing apparatus is divided at predetermined times (also called “chunk recording” hereinafter) (Patent Literature (PTL) 1). By using the technique disclosed in PTL 1, the image capturing apparatus can transmit the moving image to the external apparatus efficiently.

Moving image files generated through chunk recording (also called “chunk moving image files” hereinafter) can be handled as a single moving image by combining the files in the destination external apparatus. As such, it is necessary for the destination external apparatus to collect a file group including a series of files from the starting chunk moving image file to the ending chunk moving image file, and the files cannot be combined correctly in the external apparatus if some of the chunk moving image files are missing.

### CITATION LIST

### PATENT LITERATURE

PTL 1: Japanese Patent Laid-Open No. 2022-96304

Incidentally, systems are known in which, when shooting images on site in the mass media industry, moving image, audio, and other such files shot and recorded by an image capturing apparatus (time-series data) are transmitted to a communication apparatus such as a smartphone and stored in that apparatus, and the files are further transmitted from the communication apparatus to a server over a network. In such a system, to ensure that chunk moving image files generated by the image capturing apparatus can be transferred, without any files missing, and combined in the server, it is necessary for the communication apparatus to appropriately control the transfer of the chunk moving image files. However, PTL 1, mentioned above, does not take into consideration the transfer of chunk moving image files through a communication apparatus.

### SUMMARY

Having been achieved in light of the stated issue, the present disclosure is provided to realize a technique which, when transferring time-series data such as moving image files to an external apparatus, makes it possible to prevent situations where files necessary for combining are missing.

In order to solve the aforementioned issues, one aspect of the present disclosure provides a communication apparatus comprising: a communication unit configured to communicate with an external apparatus; a control unit configured to, in a case where a file is generated in a first external apparatus, perform control to obtain the file from the first external apparatus via the communication unit; and a transfer unit configured to, in a case where the file is obtained, transfer the file to a second external apparatus via the communication unit, wherein in a case where a first divided file is generated in the first external apparatus as a divided file generated in sequence by dividing continuous time-series data, the control unit controls whether to obtain the first divided file from the first external apparatus, in accordance with an obtainment status of a divided file from a start of the time-series data to a divided file prior to the first divided file.

Other features and advantages of the disclosure will be apparent from the following description taken in conjunction with the accompanying drawings. Note that the same reference numerals denote the same or like components throughout the accompanying drawings.

### BRIEF DESCRIPTION OF DRAWINGS

The accompanying drawings, which are incorporated in and constitute a part of the specification, illustrate embodiments of the disclosure and, together with the description, serve to explain principles of the disclosure.

FIG. 1 is a conceptual diagram illustrating an example of the configuration of a system according to a first embodiment.

FIG. 2A is a block diagram illustrating an example of the configuration of an image capturing apparatus according to the first embodiment.

FIG. 2B is a diagram illustrating an example of the external appearance of the image capturing apparatus according to the first embodiment.

FIG. 3 is a block diagram illustrating an example of the configuration of a communication apparatus according to the first embodiment.

FIG. 4A is a diagram (1) illustrating chunk recording according to the first embodiment.

FIG. 4B is a diagram (2) illustrating chunk recording according to the first embodiment.

FIG. 5AA illustrates an example (1) of a screen in a transfer app controlled by the communication apparatus according to the first embodiment.

FIG. 5AB illustrates an example (2) of a screen in the transfer app controlled by the communication apparatus according to the first embodiment.

FIG. 5BC illustrates an example (3) of a screen in the transfer app controlled by the communication apparatus according to the first embodiment.

FIG. 5BD illustrates an example (4) of a screen in the transfer app controlled by the communication apparatus according to the first embodiment.

FIG. 6A is a sequence chart (1) illustrating an example of operations in file transfer processing during proxy recording and chunk recording, according to the first embodiment.

FIG. 6B is a sequence chart (2) illustrating an example of operations in file transfer processing during proxy recording and chunk recording, according to the first embodiment.

FIG. 7A is a flowchart (1) illustrating a series of operations in shooting/automatic transfer by the communication apparatus according to the first embodiment.

FIG. 7B is a flowchart (2) illustrating a series of operations in shooting/automatic transfer by the communication apparatus according to the first embodiment.

FIG. 8A is a sequence chart (1) illustrating an example of operations when chunk recording is started after starting shooting/automatic transfer processing, according to the first embodiment.

FIG. 8B is a sequence chart (2) illustrating an example of operations when chunk recording is started after starting shooting/automatic transfer processing, according to the first embodiment.

FIG. 9A is a sequence chart (1) illustrating an example of operations when shooting/automatic transfer is started after starting chunk recording, according to the first embodiment.

FIG. 9B is a sequence chart (2) illustrating an example of operations when shooting/automatic transfer is started after starting chunk recording, according to the first embodiment.

FIG. 10 is a flowchart illustrating a series of operations in automatic transfer processing by a communication apparatus according to a second embodiment.

FIG. 11 is a sequence chart illustrating an example of operations when performing automatic transfer processing according to the second embodiment.

FIG. 12 is an example of a screen displaying a warning message when a shooting/automatic transfer function is performed during chunk recording according to the second embodiment.

### DESCRIPTION OF THE EMBODIMENTS

Hereinafter, embodiments will be described in detail with reference to the attached drawings. Note, the following embodiments are not intended to limit the scope of the disclosure. Multiple features are described in the embodiments, but limitation is not made to the disclosure that requires all such features, and multiple such features may be combined as appropriate. Furthermore, in the attached drawings, the same reference numerals are given to the same or similar configurations, and redundant description thereof is omitted.

### First Embodiment

### Overview of Transfer of Chunk Moving Image File

An overview of the transfer of a chunk moving image file according to the present embodiment will be given first. At sites in the mass media industry where images are shot, such as news companies and telecommunication companies, it is necessary to quickly deliver content shot at the site of an interview to the news company or the like, and file transfer solutions which use network communication are currently being provided. Specifically, image/moving image/audio files shot and recorded by an image capturing apparatus are transmitted to a communication apparatus such as a smartphone and stored within the apparatus. A mobile application is provided which then transmits those files from the communication apparatus to an external FTP server over a network. Such a mobile application includes a function for automatically performing the following series of processes (also called a “shooting/automatic transfer function” hereinafter). In the shooting/automatic transfer function, the mobile application receives a notification that the recording of a moving image file is complete from the image capturing apparatus using, for example, Picture Transfer Protocol over Internet Protocol (PTP/IP). The moving image file is then obtained, and the obtained moving image file is transferred to the external FTP server. By activating the shooting/automatic transfer function, a user can automatically deliver captured files to an external destination without performing operations for selecting the files.

However, chunk moving image files generated through chunk recording are typically combined at the destination and handled as a single moving image. Accordingly, at the time of delivery, it is necessary to collect a group including a series of files, from the starting chunk moving image file to the ending chunk moving image file. If the chunk moving image files are delivered with some of the files missing, the files cannot be combined correctly at the destination. When the shooting/automatic transfer function is active, it becomes possible to receive a notification that the recording of a moving image file is complete from the image capturing apparatus. Thereafter, when the communication apparatus receives a notification that the recording of a moving image file is complete from the image capturing apparatus, the moving image file is obtained from the image capturing apparatus and transferred to the external FTP server. If the processing sequence of the shooting/automatic transfer function is also applied to chunk recording, it is possible, for example, that the chunk recording had already been started on the image capturing apparatus side at the time when the function was active. In this case, the communication apparatus cannot receive, from the image capturing apparatus, a notification that the recording of a chunk moving image file which was recorded before the function was active is complete. If, for example, moving image files for which the notification that recording is complete has been received are obtained as-is and transferred to the external apparatus, the files will ultimately be delivered in a state in which the earlier chunk moving image files, which are necessary for the combination at the destination, are missing.

In order to prevent such missing chunk moving image files, in the present embodiment, if a chunk moving image file from the start of the moving image to the divided file prior to the chunk moving image file to be processed has not been transferred, subsequent chunk moving image files are not transferred. This will be described in detail hereinafter.

Although the following will describe an example in which a moving image file is transferred, the present embodiment is not limited to moving images, and can also be applied when applying chunk recording to time-series data including moving image, audio, and other such data. In this case, the chunk moving image file corresponds to a divided file generated in sequence by dividing continuous time-series data.

### Example of System Configuration

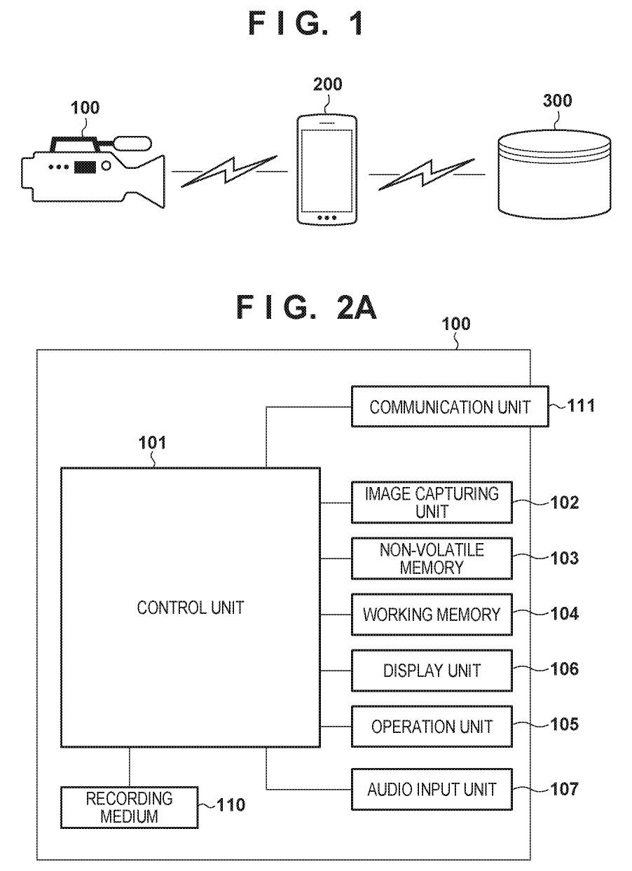

An example of the configuration of a system according to a first embodiment will be described with reference to FIG. 1. In FIG. 1, 100 indicates an image capturing apparatus such as a digital video camera. As will be described later, the image capturing apparatus may be a different device, as long as the device is configured to be capable of obtaining time-series data such as moving images. 200 indicates a communication apparatus such as a mobile terminal having a communication function, as represented by a smartphone, for example. 300 indicates a server serving as one example of an image storage apparatus, which can be installed at a connection destination connected over a communication network such as the Internet.

In FIG. 1, the image capturing apparatus 100 and the communication apparatus 200 are connected by a hardwire cable, Wi-Fi, or the like, and are capable of communicating over wires or wirelessly. The image capturing apparatus 100 can, for example, transfer moving image files generated by the image capturing apparatus 100 to the communication apparatus 200. The communication apparatus 200 and the server 300 can communicate using a wireless LAN, mobile communication, or the like. The communication apparatus 200 can, for example, transfer information stored in the communication apparatus 200 to the server 300 using a communication protocol such as FTP. Note, however, that the system configuration is not limited to the foregoing example, and the processing for transferring files among the apparatuses may be realized by the image capturing apparatus 100, the communication apparatus 200, and the server 300 connecting to the same network through access points, rather than using mobile communication.

### Configuration of Image Capturing Apparatus 100

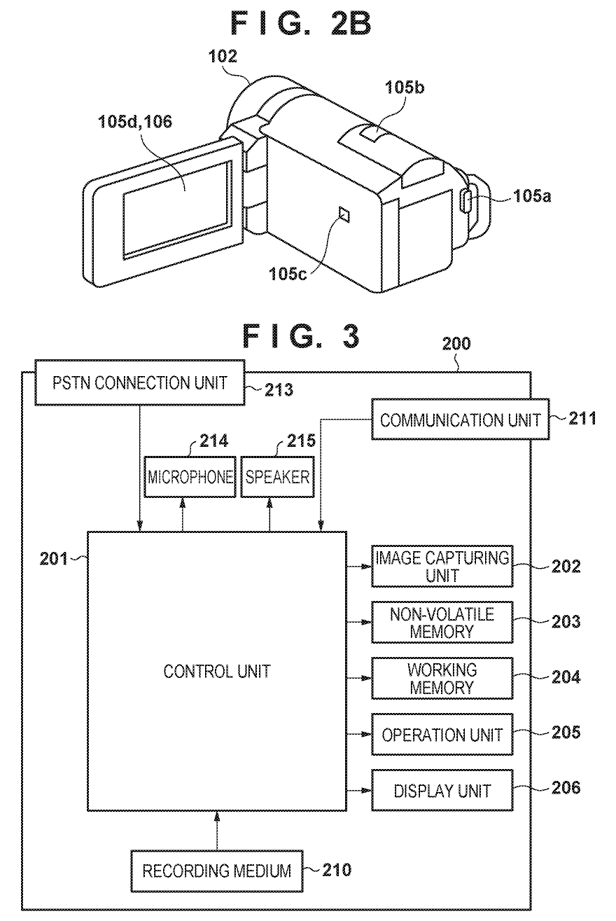

An example of the configuration of the image capturing apparatus 100 according to the present embodiment will be described with reference to FIG. 2A. Although the following will describe a case where a digital video camera is used as the image capturing apparatus as an example, the image capturing apparatus is not limited thereto. The image capturing apparatus may be a portable media player, what is known as a tablet device, a personal computer, or the like.

A control unit 101 includes one or more processors, and controls the various units of the image capturing apparatus 100 (the entire image capturing apparatus) in accordance with input signals, programs (described later), and the like. Note that a plurality of pieces of hardware may control the overall apparatus by sharing processing rather than the control unit 101 controlling the overall apparatus.

An image capturing unit 102 is constituted by, for example, an optical system that controls an optical lens unit as well as aperture, zoom, and focus, an image sensor for converting light (an image) entering through the optical lens unit into an electrical image signal, and the like. A Complementary Metal Oxide Semiconductor (CMOS), a Charge Coupled Device (CCD), or the like is typically used as the image sensor. Under the control of the control unit 101, the image capturing unit 102 uses the image sensor to convert subject light, formed as an image by a lens included in the image capturing unit 102, into an electrical signal, performs noise reduction processing and the like, and outputs digital data as moving image data. In the image capturing apparatus 100 according to the present embodiment, the moving image data is recorded into a recording medium 110, for example.

A non-volatile memory 103 is a non-volatile memory that can be electrically erased and recorded to, and stores programs and the like (described later) that are executed by the control unit 101.

A working memory 104 is used as a buffer memory that temporarily stores the moving image data captured by the image capturing unit 102, moving image display memory for a display unit 106, a work region for the control unit 101, and the like. The working memory 104 may be a volatile memory.

An operation unit 105 is used for accepting instructions, made by a user in the image capturing apparatus 100, from the user. For example, the operation unit 105 includes a power button through which the user instructs the power of the image capturing apparatus 100 to be turned on and off, a release switch for instructing the start/stop of shooting, a playback button for instructing the playback of moving image data, and the like. The operation unit 105 further includes operation members such as a dedicated “connect” button for starting communication with an external device via a communication unit 111 (described later). The operation unit 105 also includes a touch panel formed on the display unit 106 (described later).

The display unit 106 displays a viewfinder image at the time of shooting, shot moving image data, text for interactive operations, and the like. Note that the display unit 106 does not absolutely need to be built into the image capturing apparatus 100. It is sufficient for the image capturing apparatus 100 to be capable of connecting to an internal or external display unit 106 and have at least a display control function for controlling the display in the display unit 106.

An audio input unit 107 is a device for inputting audio information, and audio data obtained by way of the audio input unit 107 converting audio information is recorded into the recording medium 110 in an audio file format.

The recording medium 110 can record the moving image data output from the image capturing unit 102 and the audio data output from the audio input unit 107. The recording medium 110 according to the present embodiment includes two slots, for example. When processing moving image data from the image capturing unit 102, the control unit 101 records, into the first slot of the recording medium 110, a high-resolution moving image file designated by the user (“main moving image file”, hereinafter), at the resolution of the image sensor (included in the image capturing unit 102; not shown). On the other hand, the control unit 101 records, into the second slot of the recording medium 110, a low-resolution or low-bitrate moving image file (“proxy moving image file”, hereinafter), a chunk moving image file obtained by chunk recording, and the like, which are to be transmitted from the communication unit 111 to the communication apparatus 200 over the network. The recording medium 110 may be configured to be removable from the image capturing apparatus 100, or may be built into the image capturing apparatus 100. In other words, it is sufficient for the image capturing apparatus 100 to at least be capable of accessing the recording medium 110.

The communication unit 111 is an interface for connecting to an external apparatus. The image capturing apparatus 100 of the present embodiment can exchange data with the external apparatus through the communication unit 111. For example, the moving image data generated by the control unit 101, the audio data generated by the audio input unit 107, and the like can be transmitted to the external apparatus through the communication unit 111. In the present embodiment, the communication unit 111 includes an interface for communicating with the external apparatus over what is known as a wireless LAN according to the IEEE 802.11 standard. The communication unit 111 also includes a Universal Serial Bus (USB) interface for connecting to the external apparatus using a USB cable. The control unit 101 implements wireless and wired communication with the external apparatus by controlling the communication unit 111.

Note that the communication unit 111 of the image capturing apparatus 100 according to the present embodiment is capable of operating in an access point mode (“AP mode”, hereinafter) so as to operate as an access point in infrastructure mode. The communication unit 111 is furthermore capable of operating in a client mode (“CL mode”, hereinafter) so as to operate as a client in an infrastructure mode. By operating the communication unit 111 in CL mode, the image capturing apparatus 100 of the present embodiment can operate as a CL device in infrastructure mode. When the image capturing apparatus 100 operates as a CL device, the image capturing apparatus 100 can join a network formed by a nearby AP device by connecting to the AP device. In addition, by operating the communication unit 111 in AP mode, the image capturing apparatus 100 according to the present embodiment can operate as a simplified AP (“simple AP”, hereinafter) which is a kind of AP, but has limited functions. When the image capturing apparatus 100 operates as a simple AP, the image capturing apparatus 100 forms a network itself. A device in the vicinity of the image capturing apparatus 100 can recognize the image capturing apparatus 100 as an AP device and join the network formed by the image capturing apparatus 100. A program for causing the image capturing apparatus 100 to function as described above is held in the non-volatile memory 103. Note that the image capturing apparatus 100 may be a simple AP that, while being a kind of AP, does not have a gateway function for transferring data received from a CL device to an Internet provider or the like. In this case, even if the image capturing apparatus 100 receives data from another apparatus that has joined the network formed by the image capturing apparatus 100, that data cannot be transferred to a network such as the Internet.

Next, the external appearance of the image capturing apparatus 100 will be described with reference to FIG. 2B. A release switch 105a, a zoom lever 105b, a playback button 105c, and a touch panel 105d are operation members included in the operation unit 105 described above. Moving images obtained as a result of the capturing by the image capturing unit 102 are also displayed on the display unit 106.

### Example of Configuration of Communication Apparatus 200

Next, an example of the configuration of the communication apparatus 200 of the present embodiment will be described with reference to FIG. 3. Although a case where a mobile terminal is used as the communication apparatus 200 will be described as an example, the communication apparatus 200 is not limited thereto. The communication apparatus 200 may be a digital video camera having wireless functionality, a tablet device, a personal computer, or the like, for example.

A control unit 201 includes one or more processors, and controls the various units of the communication apparatus 200 (the entire communication apparatus) in accordance with input signals, programs (described later), and the like. Note that a plurality of pieces of hardware may control the overall apparatus by sharing processing rather than the control unit 201 controlling the overall apparatus.

An image capturing unit 202 converts subject light, formed as an image by a lens included in the image capturing unit 202, into an electrical signal, performs noise reduction processing and the like, and outputs digital data as moving image data. The captured moving image data is stored in a buffer memory, subjected to predetermined processing by the control unit 201, and is then recorded into a recording medium 210.

A non-volatile memory 203 is a non-volatile memory that can be electrically erased and recorded to. An operating system (OS), which is basic software executed by the control unit 201, applications that implement practical functions by operating cooperatively with the OS, and the like are recorded in the non-volatile memory 203. In the present embodiment, a transfer application (“transfer app”, hereinafter) for the communication apparatus 200 to transfer data with the image capturing apparatus 100 and the server 300 is also stored in the non-volatile memory 203. A file management application (“file management app”, hereinafter) and an image management application (“image management app”, hereinafter), which manage moving image files and audio files transmitted from the image capturing apparatus 100, are also stored.

A working memory 204 is used as an image display memory for a display unit 206, a work region for the control unit 201, and the like. In the present embodiment, when transferring moving image files received from the image capturing apparatus 100 to the server 300, those files are stored temporarily. The working memory 204 may be a volatile memory.

An operation unit 205 is used for accepting instructions made to the communication apparatus 200 by a user. The operation unit 205 includes operation members such as, for example, a power button through which the user instructs the power of the communication apparatus 200 to be turned on and off, a touch panel formed on the display unit 206, and the like.

The display unit 206 displays moving image data, a text display for interactive operations, and the like. Note that the communication apparatus 200 does not absolutely need to include the display unit 206. It is sufficient for the communication apparatus 200 to be capable of connecting to the display unit 206 and have at least a display control function for controlling the display in the display unit 206.

The recording medium 210 can record image data output from the image capturing unit 202. The recording medium 210 may be configured to be removable from the communication apparatus 200, or may be built into the communication apparatus 200. In other words, it is sufficient for the communication apparatus 200 to at least be capable of accessing the recording medium 210.

A communication unit 211 is an interface for communicating with an external apparatus. The communication apparatus 200 of the present embodiment can exchange data with the image capturing apparatus 100 and the server 300 through the communication unit 211. In the present embodiment, the communication unit 211 is an antenna, for example, and the control unit 101 can connect to the image capturing apparatus 100 via the antenna. Note that the connections with the image capturing apparatus 100 in the server 300 may be direct connections, or may be connections made via an access point. The PTP/IP protocol over wireless LAN, for example, can be used as the protocol for communicating data.

The communication unit 211 also includes a Universal Serial Bus (USB) interface for connecting to the external apparatus using a USB cable. Note, however, that the communication with the external apparatus is not limited thereto. For example, the communication unit 211 can include an infrared communication module, a Bluetooth (registered trademark) communication module, a wireless communication module such as Wireless USB, or the like.

A PSTN connection unit 213 is an interface used when performing public wireless line communication. The communication apparatus 200 can make voice calls with other devices through the PSTN connection unit 213. At this time, the voice calls are implemented by the control unit 201 inputting and outputting audio signals via a microphone 214 and a speaker 215.

The communication apparatus 200 of the present embodiment can exchange data with the server 300 through the PSTN connection unit 213 as well. The PSTN connection unit 213 is an antenna, for example, and the control unit 101 can connect to a public network via the antenna. Note that the communication unit 211 and the PSTN connection unit 213 can also share a single antenna. Communication performed through the communication unit 211 is typically faster than communication performed over a public network. As such, in the communication apparatus 200 of the present embodiment, communication performed through the communication unit 211 is prioritized when a call is not being made.

### Chunk Recording File

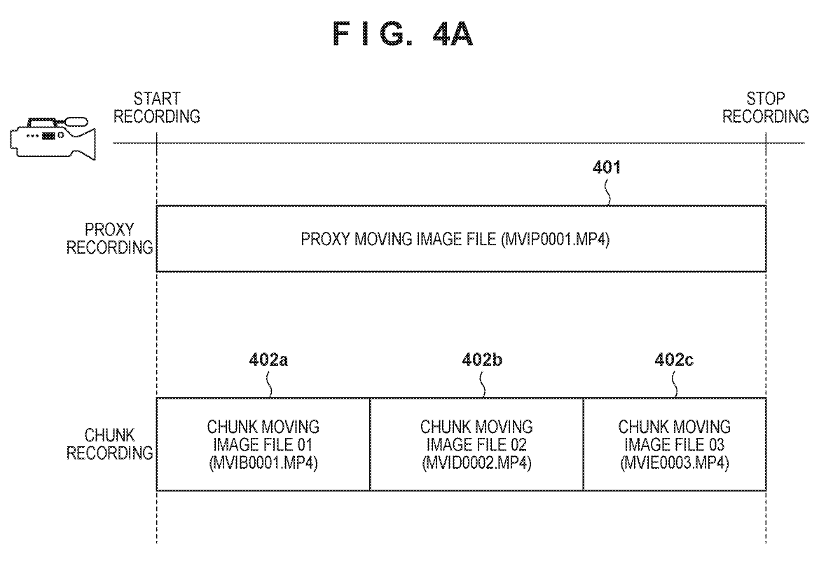

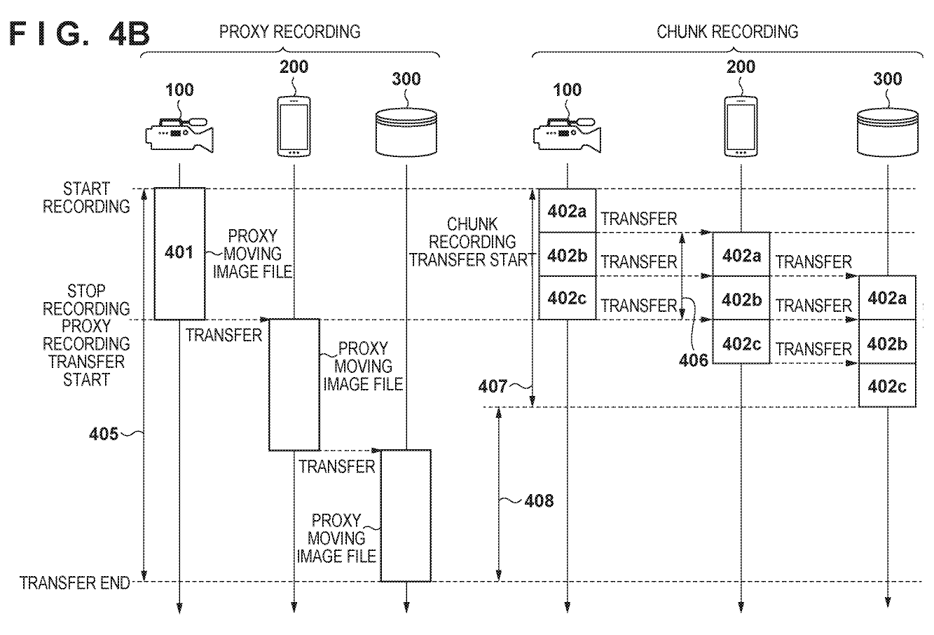

Next, two recording modes used when the image capturing apparatus 100 of the present embodiment records a low-resolution or low-bitrate moving image file in the recording medium 110 in MP4 file format will be described with reference to FIGS. 4A and 4B. The image capturing apparatus 100 starts recording a moving image in response to the user pressing the release switch 105a, and stops the recording in response to the release switch 105a being pressed again.

A first mode for recording a moving image file is “proxy recording”. In proxy recording, the image capturing apparatus 100 records a proxy moving image file recorded at the same recording time as the main moving image file. 401 indicates a proxy moving image file in which the recording time of the moving image is from the start of recording to the end of recording. In other words, proxy recording is a recording mode in which a single proxy moving image file is generated from the start of recording to the end of recording.

In the present embodiment, when generating a filename for the proxy moving image file 401, for example, the image capturing apparatus 100 sets the fourth letter, following “MVI”, to “P”, and then adds a file number and an extension. As such, the image capturing apparatus 100 sets the filename of the proxy moving image file to, for example, “MVIP0001.MP4”.

A second mode for recording a moving image file is “chunk recording”. In chunk recording, the image capturing apparatus 100 records chunk moving image files by dividing a moving image into smaller chunks each time a predetermined length of time passes during recording. The image capturing apparatus 100 generates a new chunk moving image file when a predetermined length of time has passed from the start of recording or from the timing at which the previous chunk moving image file was generated. For example, the image capturing apparatus 100 generates a chunk moving image file 402a when 30 seconds have passed following the start of recording. When 30 seconds have passed from when the chunk moving image file 402a was generated, the image capturing apparatus 100 generates a chunk moving image file 402b. In the example illustrated in FIGS. 4A and 4B, the image capturing apparatus 100 records chunk moving image files at 30-second intervals up to 402b. When the user presses the release switch 105a and the recording is stopped, the image capturing apparatus 100 generates a chunk moving image file 402c corresponding to the time from when the chunk moving image file 402b was generated to when the recording was ended.

In the present embodiment, the image capturing apparatus 100 can add filenames to chunk moving images according to a predetermined naming convention, for example. The naming convention for chunk moving image filenames can be as follows, for example. Text indicating that the chunk moving image file 402a generated first is a starting moving image file (generated at the start of the recording) is added to that chunk moving image file. For example, the image capturing apparatus 100 sets the fourth letter, following “MVI”, to “B”. In this case, the filename of the chunk moving image generated first is “MVIB0001.MP4”.

Text indicating that the chunk moving image file 402b generated next is an intermediate moving image file is added to that chunk moving image file. For example, the image capturing apparatus 100 sets the fourth letter, following “MVI”, to “D”. In this case, the filename of the chunk moving image generated next is “MVID0002.MP4”.

Text indicating that the chunk moving image file 402c generated last is an ending moving image file (generated at the end of the recording) is added to that chunk moving image file. For example, the image capturing apparatus 100 sets the fourth letter, following “MVI”, to “E”. In this case, the filename of the chunk moving image file generated last is “MVIE0003.MP4”.

Using a naming convention in which specific predetermined text is added to the filename (e.g., a naming convention that assigns the fourth letter) in this manner enables a communication apparatus or the like that has obtained the file to determine whether the recording mode is chunk recording or proxy recording (described later). Whether the moving image file in question is the starting moving image file, an intermediate moving image file, or the ending moving image file can also be identified from the fourth letter.

Advantages of chunk recording will be described next with reference to FIG. 4B, using, as an example, a case where a moving image file is transferred from the image capturing apparatus 100 to the server 300 via the communication apparatus 200. When performing proxy recording, the image capturing apparatus 100 cannot transmit a moving image file that is currently being recorded, and therefore starts transmitting the proxy moving image after the recording is complete. In this case, in addition to the time required to record the proxy moving image file 401, transmitting the proxy moving image file 401 takes time as well. 405 in FIG. 4B indicates the time taken from when proxy moving image recording is started to when the transfer of the proxy moving image file 401 is complete.

When performing chunk recording, the image capturing apparatus 100 can successively transmit generated chunk moving image files even while a moving image is being recorded. For example, once the chunk moving image file 402a has been generated (i.e., once the recording to the corresponding file is complete), the chunk moving image file 402a can be transferred, even if the image capturing apparatus 100 is still recording. In the example in FIG. 4B, the image capturing apparatus 100 can start transferring the moving image file earlier than the recording time of the proxy moving image file 401 by a differential time 406. When transferring a moving image file generated through chunk recording, the time from when recording is started to when the transmitting of the moving image file is complete is represented by 407. This therefore provides an advantage in that the transfer time 407 for chunk recording is earlier than the transfer time 405 for proxy recording by a differential time 408.

### Examples of Transfer Application Screens

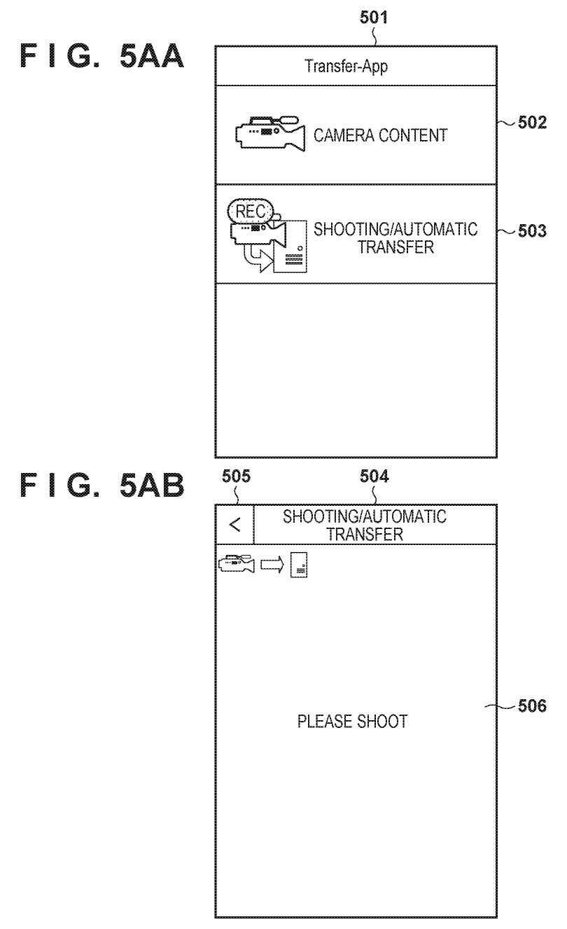

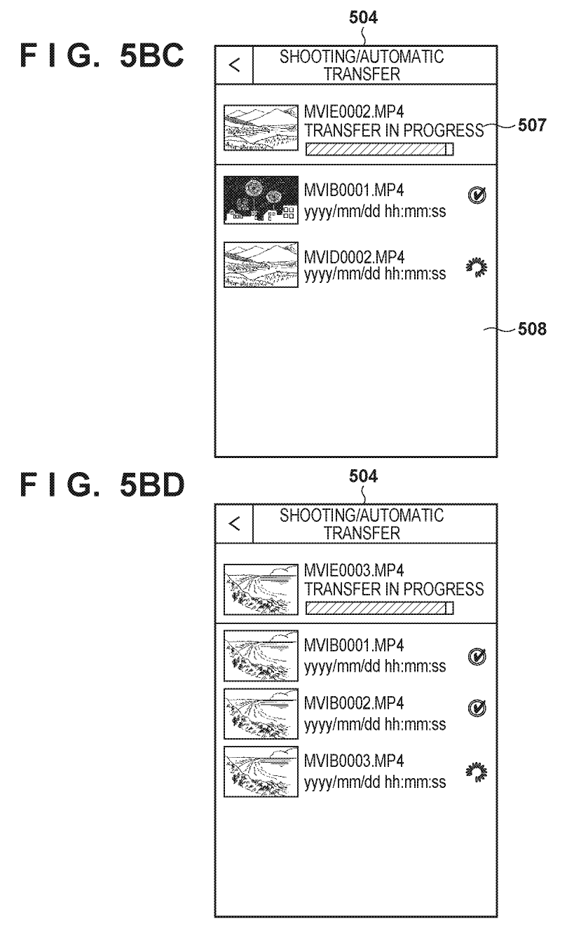

Examples of operation screens of a transfer application (also called simply a “transfer app”), which are displayed in the display unit 206 of the communication apparatus 200 of the present embodiment, will be described next with reference to FIGS. 5AA, 5AB, 5BC, and 5BD,. FIGS. 5AA, 5AB, 5BC, and 5BD, schematically illustrate display states of operation screens of the transfer app. The transfer app causes, for example, a function selection screen 501, a camera content list screen, and a shooting/automatic transfer screen 504 to be displayed in response to user operations.

The function selection screen 501 illustrated in FIG. 5AA is a screen displayed while the image capturing apparatus 100 is connected following the transfer app being launched. The function selection screen 501 includes, for example, a camera content list display button 502 and a shooting/automatic transfer button 503. The camera content list display button 502 is a button for obtaining content (e.g., moving image files) recorded in the image capturing apparatus 100 and transitioning to the camera content list screen (described later). The shooting/automatic transfer button 503 is a button for transitioning to the shooting/automatic transfer screen 504 for transferring content received from the image capturing apparatus 100 to another apparatus (e.g., the server 300). When the camera content list display button 502 is pressed, the communication apparatus 200 transitions to the camera content list screen (not shown). The camera content list screen is a screen that displays a list of files recorded in the image capturing apparatus 100. The communication apparatus 200 can display the obtained content in a list using a publicly-known method, for example. Additionally, when the shooting/automatic transfer button 503 is pressed, the communication apparatus 200 transitions to the shooting/automatic transfer screen 504.

In the shooting/automatic transfer screen 504 illustrated in FIG. 5AB, the communication apparatus 200 displays files transferred from the image capturing apparatus 100 to the server 300 via the communication apparatus 200. In the present embodiment, upon transitioning to the shooting/automatic transfer screen 504, the communication apparatus 200 becomes capable of receiving a moving image file generation notification from the image capturing apparatus 100. 505 indicates a button for returning to the previous screen. 506 indicates an initial screen of the shooting/automatic transfer screen 504, which is displayed when no transfers are underway (when no transferred content is present).

In the shooting/automatic transfer screen 504 illustrated in FIG. 5BC, the communication apparatus 200 displays an indication of the proxy moving image file, recorded by the image capturing apparatus 100, being transferred to an external apparatus (e.g., the server 300). Specifically, the communication apparatus 200 displays information of the moving image file currently being transferred in a display area of a current transfer content status 507. The information of the moving image file currently being transferred includes a thumbnail image and a filename, for example. The information pertaining to the moving image files is included in the data of the moving image file generation notification from the image capturing apparatus 100, for example, and the communication apparatus 200 can display the information by referring to the data of the moving image file generation notification.

The communication apparatus 200 also displays a text string and a progress bar indicating the progress of the transfer of the content. The progress is updated according to whether processing is underway for obtaining the moving image file from the image capturing apparatus 100 or transmitting the moving image file to the server 300. The length of the progress bar is updated according to the size of the data of the moving image file already obtained from the image capturing apparatus 100 and the size of the data already transmitted to the server 300.

The communication apparatus 200 displays, in the display area of a transfer content list 508, a list of information of the moving image files transferred after transitioning to the shooting/automatic transfer screen 504. The display of the information of each moving image file includes displaying a thumbnail image, a filename, and a status icon indicating the transfer progress. The status icon indicates whether transfer processing is in progress or the transfer is complete. For example, the communication apparatus 200 displays information “MVIP0001.MP4” along with an icon indicating that the transfer is complete in the transfer content list 508, and displays information “MVIP0002.MP4” along an icon indicating that the transfer is in progress.

In the shooting/automatic transfer screen 504 illustrated in FIG. 5BD, the communication apparatus 200 displays an indication of the state of the chunk moving image file, recorded by the image capturing apparatus 100, when being transferred to the external apparatus. Note that the content displayed in the current transfer content status 507 and the transfer content list 508 is the same as in FIG. 5BC. As illustrated in FIG. 5BD, the chunk moving image files generated by the chunk recording are transferred sequentially.

### Automatic Transfer Processing Sequence

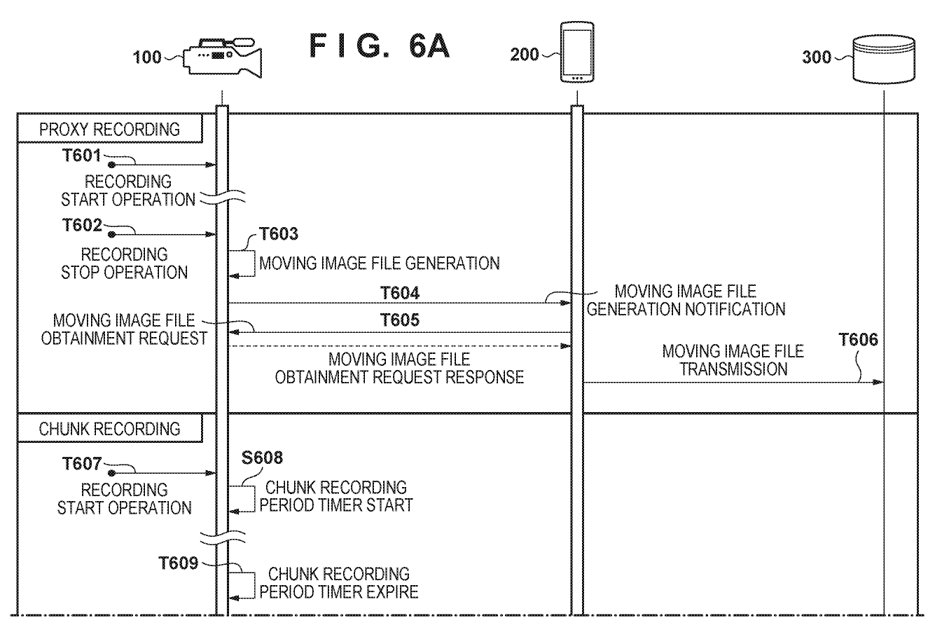

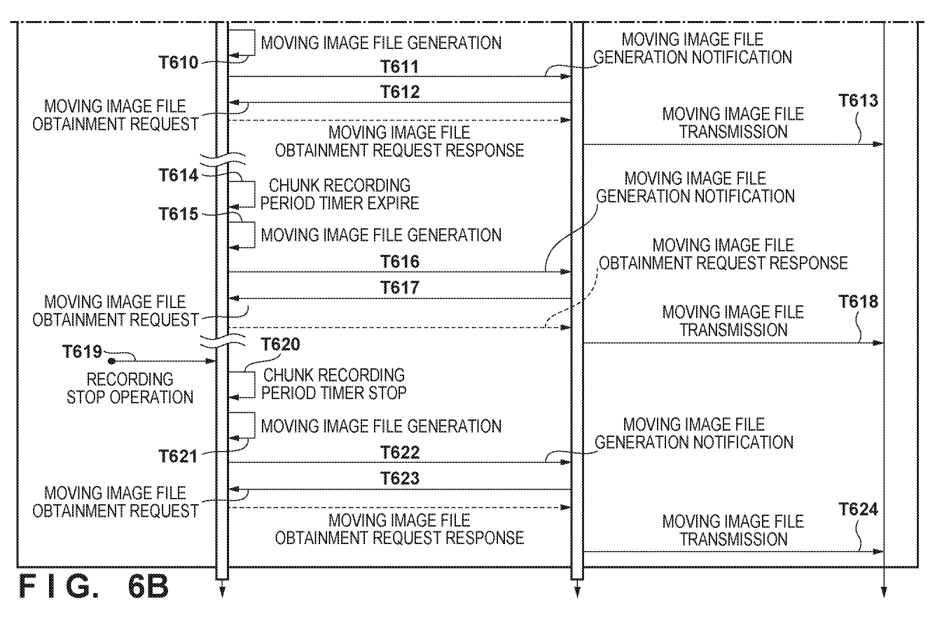

A processing sequence for automatically transferring a moving image file recorded by the image capturing apparatus 100 to the server 300 (automatic transfer processing), performed by the transfer app of the communication apparatus 200, will be described next with reference to FIGS. 6A and 6B. Note that the automatic transfer processing sequence illustrated in FIGS. 6A and 6B is processing performed after the shooting/automatic transfer screen 504 is displayed in the communication apparatus 200 and the communication apparatus 200 becomes capable of receiving a moving image file generation notification from the image capturing apparatus 100. Note also that unless otherwise specified, in the processing sequence described below, processes described as being performed by the image capturing apparatus 100 are realized by the control unit 101 loading a program stored in the non-volatile memory 103 into the working memory 104 and executing the program to control the various units of the image capturing apparatus 100. Likewise, processes described as being performed by the communication apparatus 200 are realized by the control unit 201 loading a program stored in the non-volatile memory 203 into the working memory 204 and executing the program to control the various units of the communication apparatus 200.

### When Moving Image Recording Is Proxy Recording in Automatic Transfer Processing

A case where the moving image recording is proxy recording in the automatic transfer processing will be described first. At T601, upon receiving an operation for starting recording from the user while a proxy recording setting is active, the image capturing apparatus 100 starts proxy recording. Upon receiving an operation for stopping recording from the user at T602, the image capturing apparatus 100 generates a proxy moving image file at T603. At T604, the image capturing apparatus 100 transmits a moving image file generation notification pertaining to the proxy moving image to the communication apparatus 200. The moving image file generation notification is a message notifying the communication apparatus 200 that a moving image file has been generated. At T605, upon receiving the moving image file generation notification, the communication apparatus 200 transmits a moving image file obtainment request to the image capturing apparatus 100. The communication apparatus 200 then obtains a moving image file in response to the transmitted moving image file obtainment request from the image capturing apparatus 100.

At T606, the communication apparatus 200 transmits the moving image file obtained from the image capturing apparatus 100 to the server 300. The proxy moving image file recorded by the image capturing apparatus 100 is transferred to the server 300 via the communication apparatus 200 through this series of processing.

### When Moving Image Recording Is Chunk Recording in Automatic Transfer Processing

A case where the moving image recording is chunk recording in the automatic transfer processing will be described next. At T607, upon receiving an operation for starting recording from the user while a chunk recording setting is active, the image capturing apparatus 100 starts chunk recording.

At T608, to generate a moving image file divided every predetermined length of time designated by the user, the image capturing apparatus 100 starts a period timer for chunk recording that periodically expires after a designated predetermined length of time has passed. At T609, the image capturing apparatus 100 detects that the period timer for chunk recording has expired.

At T610, the image capturing apparatus 100 generates a chunk moving image file (including a moving image of a length corresponding to the predetermined length of time). At T611, the image capturing apparatus 100 transmits a moving image file generation notification pertaining to the chunk moving image to the communication apparatus 200. The moving image file generation notification is a message making a notification that an individual chunk moving image file has been generated. At the point in time of T610 in FIG. 6B, the generated moving image file is the starting chunk moving image file. As such, the image capturing apparatus 100 sets the filename of the chunk moving image file to “MVIB0001.MP4”. At T612, the communication apparatus 200 receives the moving image file generation notification. Upon receiving the moving image file generation notification, the communication apparatus 200 transmits a moving image file obtainment request to the image capturing apparatus 100. The communication apparatus 200 obtains the chunk moving image file in a response from the image capturing apparatus 100 to the moving image file obtainment request. At T613, the communication apparatus 200 transmits the chunk moving image file obtained from the image capturing apparatus 100 to the server 300.

At T614, upon detecting the expiration of the chunk recording period timer again, the image capturing apparatus 100 generates a chunk moving image file (including a moving image of a length corresponding to the predetermined length of time) at T615. Then, at T616, the image capturing apparatus 100 transmits a generation notification for the generated chunk moving image file to the communication apparatus 200. At the point in time of T615, the generated moving image file is an intermediate chunk moving image file (not the starting chunk moving image file). As such, the image capturing apparatus 100 sets the filename of the chunk moving image file to “MVID0002.MP4”. At T617, upon receiving the moving image file generation notification, the communication apparatus 200 transmits a moving image file obtainment request to the image capturing apparatus 100. The communication apparatus 200 obtains the chunk moving image file in a response from the image capturing apparatus 100 to the moving image file obtainment request. At T618, the communication apparatus 200 transmits the chunk moving image file obtained from the image capturing apparatus 100 to the server 300.

Upon receiving a recording stop operation from the user at T619, the image capturing apparatus 100 stops the period timer for chunk recording at T620. At T621, the image capturing apparatus 100 generates a proxy moving image file. At T622, the image capturing apparatus 100 transmits a moving image file generation notification for the generated proxy moving image file to the communication apparatus 200.

At the point in time of T621 in FIG. 6B, the chunk moving image file generated is the ending chunk moving image file, and thus the image capturing apparatus 100 sets the filename of the chunk moving image file to “MVIE0003.MP4”. At T623, the communication apparatus 200 receives the moving image file generation notification. The communication apparatus 200 then transmits a moving image file obtainment request to the image capturing apparatus 100, and obtains a chunk moving image file in a response from the image capturing apparatus 100 to the moving image file obtainment request. At T624, the communication apparatus 200 transmits the moving image file obtained from the image capturing apparatus 100 to the server 300. A series of chunk moving image files generated by the image capturing apparatus 100 can be transferred to the server 300 via the communication apparatus 200 through such a series of processing.

### Automatic Transfer Processing Operations in Communication Apparatus 200

Automatic transfer processing operations performed in the communication apparatus 200, for transferring a moving image file recorded by the image capturing apparatus 100 to the server 300, will be described next. The operations in the automatic transfer processing described below include processing performed when the user attempts to start the automatic transfer in the communication apparatus 200 after the chunk recording has been started in the image capturing apparatus 100.

Specifically, this can occur when the chunk recording has already been started in the image capturing apparatus 100 (e.g., by some kind of operation or processing in the image capturing apparatus 100), and as a result, the starting chunk moving image file has already been generated. At this time, if, for example, the communication apparatus 200 is able to start the automatic transfer processing, the communication apparatus 200 does not receive the starting chunk moving image file generation notification, but instead sequentially receives generation notifications for intermediate chunk moving image files from the image capturing apparatus 100. If the corresponding chunk moving image files are sequentially obtained and transferred to the server 300 based on the received generation notifications, the communication apparatus 200 transfers the intermediate and subsequent chunk moving image files to the server 300. In other words, the preceding chunk moving image files that are also to be combined are not transferred to the server 300. To prevent such situations, the automatic transfer processing in the present embodiment includes operations that prevent intermediate and subsequent chunk moving image files from being transferred if the previous chunk moving image files that are also to be combined have not yet been transferred. The following will describe, as an example, processing for determining whether a moving image file should be transferred based on the type of the chunk moving image file generated and a flag indicating whether chunks are continuous.

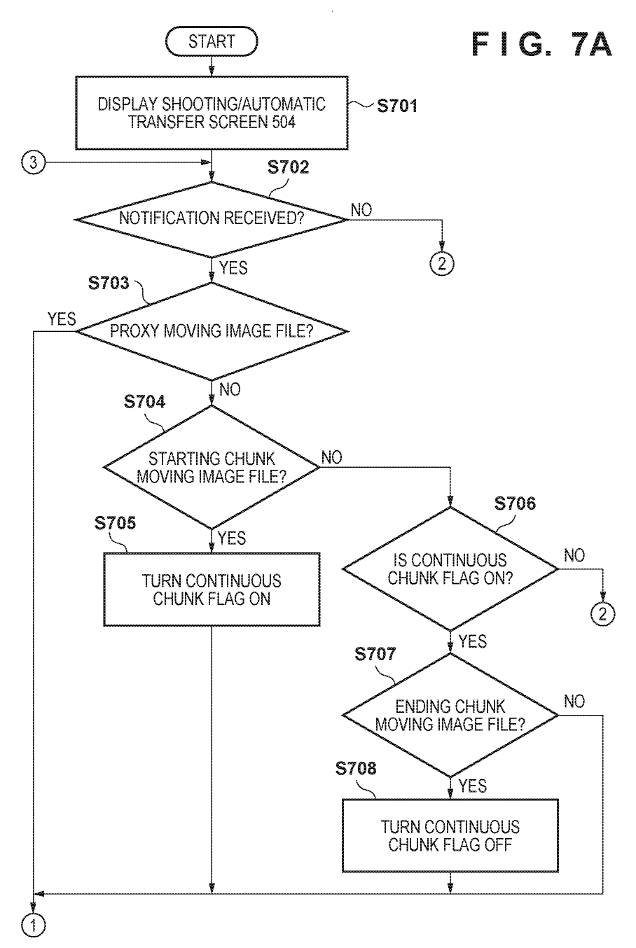

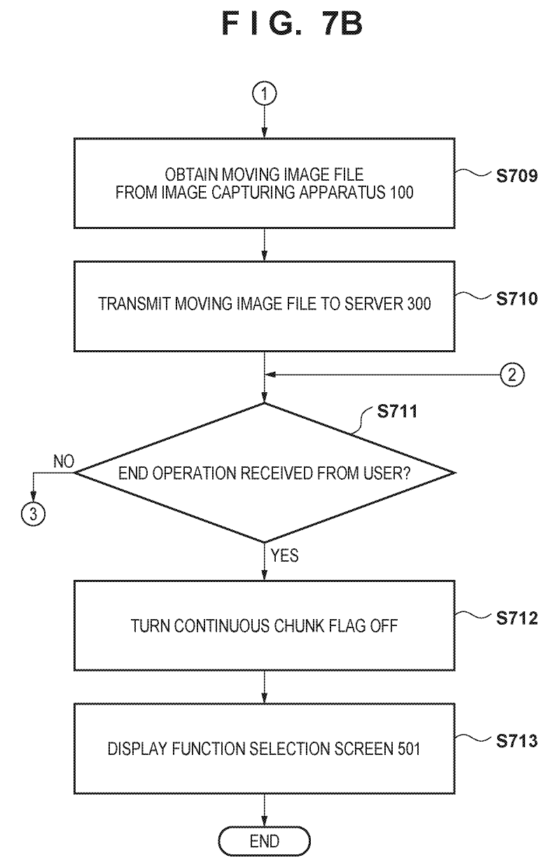

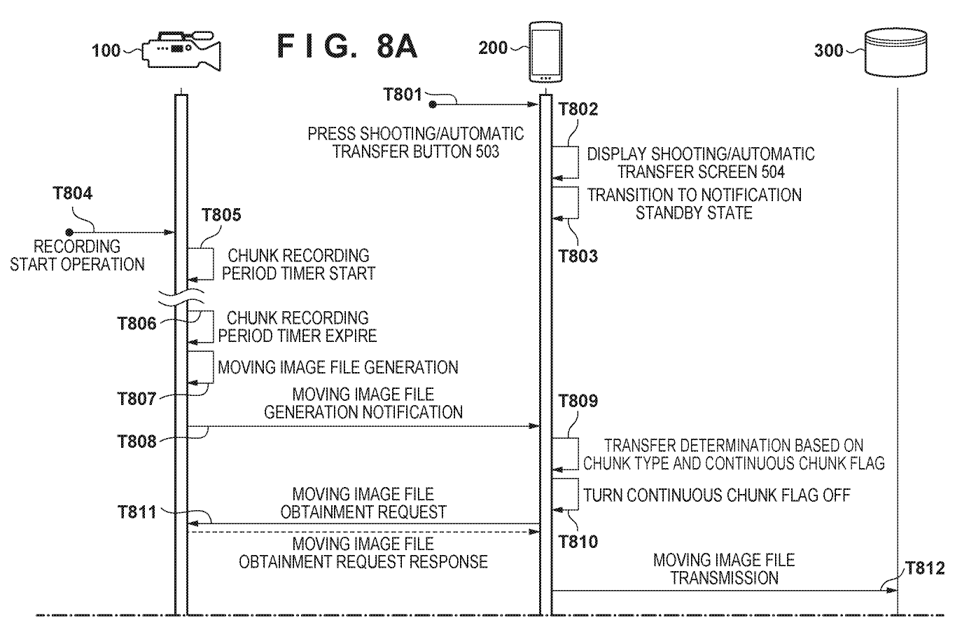

FIGS. 7A and 7B illustrate a series of operations in the automatic transfer processing performed by the communication apparatus 200. Unless specifically mentioned otherwise, the automatic transfer processing according to the present embodiment is realized by the control unit 201 loading a program stored in the non-volatile memory 203 into the working memory 204 and executing the program to control the various units of the communication apparatus 200. The operations illustrated in FIGS. 7A and 7B are started in response to the shooting/automatic transfer button 503 being pressed in the function selection screen 501, for example.

In step S701, the control unit 201 displays the shooting/automatic transfer screen 504 on the display unit 206 (in response to the shooting/automatic transfer button 503 being pressed). Note that the control unit 201 may initialize a continuous chunk flag (described later) to an off state. In step S702, the control unit 201 stands by to receive a moving image file generation notification from the image capturing apparatus 100, and determines whether the moving image file generation notification has been received from the image capturing apparatus 100. If the control unit 201 determines that the moving image file generation notification is determined to have been received, the sequence moves to step S703, and if not, the sequence moves to step S711.

In step S703, the control unit 201 determines whether the moving image file indicated by the received generation notification is a proxy moving image file. The control unit 201 determines the type of the moving image file based on the filename of the moving image file included in the received generation notification. If the type of the moving image file included in the filename indicates a proxy moving image file, the control unit 201 determines that the moving image file is a proxy moving image file. If the control unit 201 determines that the moving image file is a proxy moving image file, the sequence moves to step S709, and if not, the sequence moves to step S704. More specifically, the control unit 201 determines whether the moving image file is a proxy moving image file by, for example, determining whether the fourth letter following “MVI” in the moving image filename is “P”.

In step S704, the control unit 201 determines whether the moving image file indicated by the received generation notification is the starting chunk moving image file. The control unit 201 determines the type of the chunk moving image file based on the filename of the moving image file included in the received generation notification. If the type of the chunk moving image file included in the filename is a starting chunk moving image file, the control unit 201 moves the sequence to step S705. On the other hand, if the moving image file for which the generation notification has been received is not a starting chunk moving image file, the control unit 201 moves the sequence to step S706. More specifically, the control unit 201 determines whether the moving image file is a starting chunk moving image file by determining whether the fourth letter following “MVI” in the moving image filename is “B”.

In step S705, the control unit 201 sets the continuous chunk flag on if the moving image file indicated by the moving image file generation notification is a starting chunk moving image file. Note that the continuous chunk flag is a flag indicating whether a series of chunk moving image files to be combined has been successfully transferred starting with the starting chunk moving image file. Whether an intermediate or subsequent chunk moving image file is to be transferred is determined according to whether this flag is on.

Note that if a file is obtained from the image capturing apparatus 100 (through steps S709 and S710), that file is transferred to the server. Accordingly, the continuous chunk flag also substantially indicates “whether moving image files have been successfully obtained from the starting chunk moving image file.” Accordingly, the communication apparatus 200 can also determine whether an intermediate or subsequent chunk moving image file is to be obtained according to whether the flag is on.

In step S706, the control unit 201 determines whether the continuous chunk flag is on, and if so, moves the sequence to step S707 (because the chunk moving image file is to be transferred). On the other hand, if the continuous chunk flag is not on, the control unit 201 moves the sequence to step S711 (because the chunk moving image file is not to be transferred).

In step S707, the control unit 201 determines whether the moving image file indicated by the generation notification is an ending chunk moving image file. For example, the control unit 201 determines the type of the chunk moving image file based on the filename included in the received generation notification. If the type of the chunk moving image file is an ending chunk moving image file, the control unit 201 moves the sequence to step S708. However, if the moving image file for which the generation notification has been received is not an ending chunk moving image file, the control unit 201 moves the sequence to step S709. More specifically, the control unit 201 determines whether the moving image file is an ending chunk moving image file by determining whether the fourth letter following “MVI” in the moving image filename is “E”. In step S708, the control unit 201 sets the continuous chunk flag off (when the filename indicates an ending chunk moving image file), and moves the sequence to step S709.

In step S709, the control unit 201 transmits a moving image file obtainment request to the image capturing apparatus 100 in order to obtain a moving image file corresponding to the received generation notification, and obtains the moving image file from the image capturing apparatus 100 in response to the moving image file obtainment request. In step S710, the control unit 201 transmits the moving image file obtained from the image capturing apparatus 100 to the server 300.

In step S711, the control unit 201 determines whether the shooting/automatic transfer end operation has been accepted (by pressing the back button 505 provided in the shooting/automatic transfer screen 504). If the control unit 201 determines that the end operation has been received, the sequence moves to step S712, and if not, the sequence returns to step S702. In step S712, the control unit 201 turns off the continuous chunk flag, and in S713, the control unit 201 ends the shooting/automatic transfer function by displaying the function selection screen 501. As described above, the intermediate and subsequent chunk moving image files can be prevented from being transferred by determining whether the previous chunk moving image files that are to be combined have been transferred using the chunk moving image file type and the continuous chunk flag.

### Processing Sequence when Starting Chunk Moving Image File Has Been Received Successfully

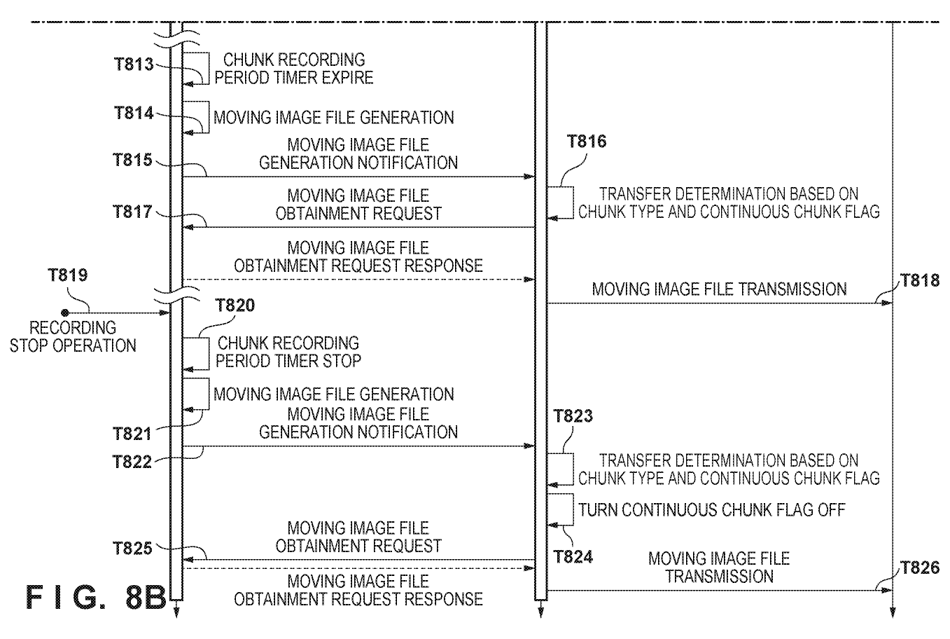

A processing sequence performed among the apparatuses when all the chunk moving image files have been successfully transferred by starting chunk recording in the image capturing apparatus 100 after the shooting/automatic transfer function has been started in the communication apparatus 200 will be described with reference to FIGS. 8A and 8B.

At T801, the communication apparatus 200 accepts the user’s pressing of the shooting/automatic transfer button 503 on the function selection screen 501. At T802, the communication apparatus 200 displays the shooting/automatic transfer screen 504 (as in step S701). At T803, the communication apparatus 200 transitions to a state of standing by for a notification from the image capturing apparatus 100, until a shooting/automatic transfer end operation is accepted from the user (through the determination processing of step S711). Although the example illustrated in FIGS. 8A and 8B is an example in which the communication apparatus 200 simply enters the standby state at T803, the communication apparatus 200 may notify the image capturing apparatus 100 that the standby state has been entered due to the shooting/automatic transfer function.

At T804, the image capturing apparatus 100 accepts a recording start operation from the user in a state where chunk recording is set to be performed, and starts chunk recording. At T805, to generate a moving image file divided every predetermined length of time designated by the user, the image capturing apparatus 100 starts a period timer for chunk recording that periodically expires after a user-designated predetermined length of time has passed.

When the chunk recording period timer expires at T806, the image capturing apparatus 100 generates a chunk moving image file at T807. At T808, the image capturing apparatus 100 transmits a moving image file generation notification for the generated moving image file to the communication apparatus 200. At this time, the generated moving image file is the starting chunk moving image file, and thus the image capturing apparatus 100 generates a moving image file generation notification indicating that the filename is “MVIB0001.MP4”.

At T809, upon receiving the moving image file generation notification from the image capturing apparatus 100, the communication apparatus 200 refers to the moving image filename, and determines that the moving image file is the starting chunk moving image file (through the determination processing in steps S703 and S704). At T810, the communication apparatus 200 turns the continuous chunk flag on (as in step S705).

At T811, the communication apparatus 200 transmits a moving image file obtainment request to the image capturing apparatus 100 (as in step S709), and obtains the moving image file from the image capturing apparatus as a response to the moving image file obtainment request. At T812, the communication apparatus 200 transmits the moving image file obtained from the image capturing apparatus 100 to the server 300 (as in step S710), and returns to a state of standing by for a notification from the image capturing apparatus 100 again (through the determination processing in step S711).

In the image capturing apparatus 100, when the (next) chunk recording period timer expires at T813, the image capturing apparatus 100 generates a chunk moving image file at T814. At T815, the image capturing apparatus 100 transmits a generation notification for the generated chunk moving image file to the communication apparatus 200. At this time, the generated moving image file is an intermediate chunk moving image file, and thus the image capturing apparatus 100 generates a moving image file generation notification indicating that the filename is “MVID0002.MP4”.

At T816, upon receiving the moving image file generation notification, the communication apparatus 200 refers to the moving image filename, and determines that the moving image file is not a starting chunk moving image file (through the determination processing in steps S703 and S704). Next, the communication apparatus 200 determines whether the continuous chunk flag is on (as in step S706), and determines from the processing result at T810 that the continuous chunk flag is on. Furthermore, the communication apparatus 200 refers to the moving image filename, and determines that the moving image file is not the ending chunk moving image file (as in step S707).

At T817, the communication apparatus 200 transmits a moving image file obtainment request to the image capturing apparatus 100 (as in step S709), and obtains the moving image file from the image capturing apparatus as a response to the moving image file obtainment request. At T818, the communication apparatus 200 transmits the moving image file obtained from the image capturing apparatus 100 to the server 300 (as in step S710), and returns to a state of standing by for a notification from the image capturing apparatus 100 again (through the determination processing in step S711).

Upon receiving a recording stop operation from the user at T819, the image capturing apparatus 100 stops the chunk recording period timer at T820. At T821, the image capturing apparatus 100 generates the proxy moving image file, and transmits a generation notification for the proxy moving image file generated at T822 to the communication apparatus 200. At this time, the generated moving image file is the ending chunk moving image file, and thus the image capturing apparatus 100 generates a moving image file generation notification indicating that the filename is “MVIE0003.MP4”.

At T823, upon receiving the moving image file generation notification, the communication apparatus 200 refers to the moving image filename, and determines that the moving image file is not a starting chunk moving image file (through the determination processing in steps S703 and S704). Next, the communication apparatus 200 determines whether the continuous chunk flag is on (as in step S706), and determines from the processing result at T810 that the continuous chunk flag is on. Furthermore, the communication apparatus 200 refers to the moving image filename, and determines that the moving image file is the ending chunk moving image file (as in step S707). At T824, the communication apparatus 200 turns the continuous chunk flag off (as in step S708). At T825, the communication apparatus 200 transmits a moving image file obtainment request to the image capturing apparatus 100 (as in step S709), and obtains the moving image file from the image capturing apparatus as a response to the moving image file obtainment request. At T826, the communication apparatus 200 transmits the moving image file obtained from the image capturing apparatus 100 to the server 300 (as in step S710). In this manner, when chunk recording has been started after the shooting/automatic transfer function has been started, the series of chunk moving image files can be correctly transferred.

### Processing Sequence when Starting Chunk Moving Image File Has Not Been Received Successfully

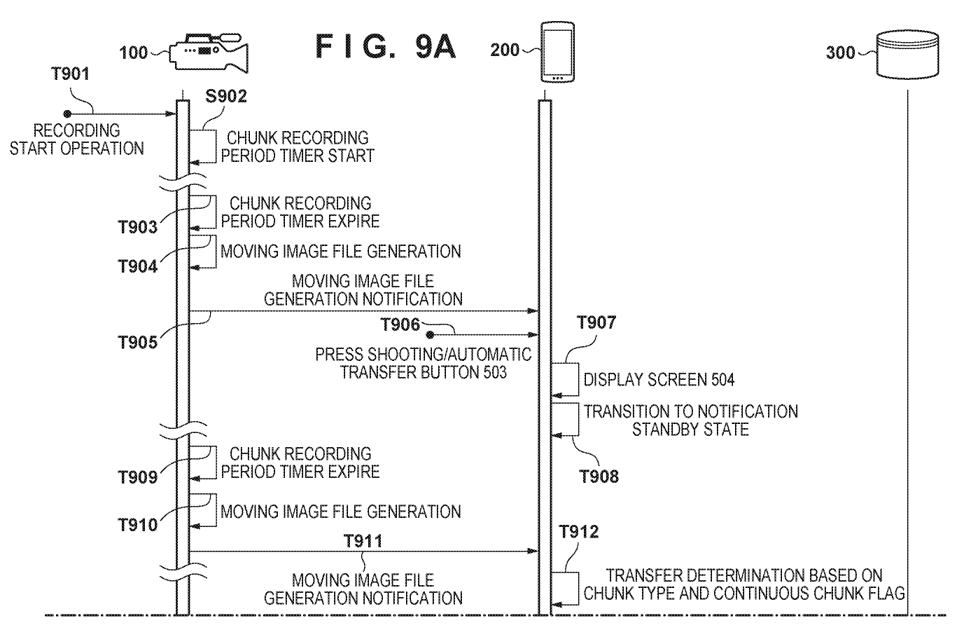

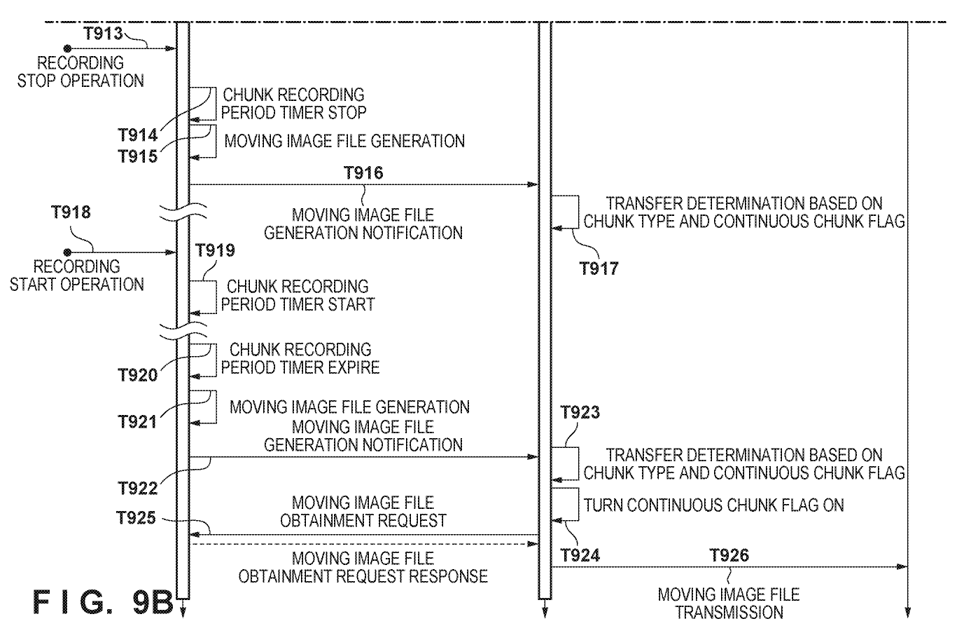

A processing sequence performed among the apparatuses when the shooting/automatic transfer function has been started by the communication apparatus 200 after the chunk recording has been started by the image capturing apparatus 100 and the starting chunk moving image file has been generated will be described with reference to FIGS. 9A and 9B.

At T901, the image capturing apparatus 100 accepts a recording start operation from the user in a state where chunk recording is set to be performed, and starts chunk recording. At T902, to generate a moving image file divided every predetermined length of time designated by the user, the image capturing apparatus 100 starts a period timer for chunk recording that periodically expires after a user-designated predetermined length of time has passed.

When the chunk recording period timer expires at T903, the image capturing apparatus 100 generates a chunk moving image file at T904. At T904, the image capturing apparatus 100 transmits a moving image file generation notification for the generated moving image file to the communication apparatus 200. At this time, the generated moving image file is the starting chunk moving image file, and thus the image capturing apparatus 100 generates a moving image file generation notification indicating that the filename is “MVIB0001.MP4”. Here, the communication apparatus 200 has not received the moving image file generation notification from the image capturing apparatus 100, and thus does nothing.

At T906, the communication apparatus 200 accepts the user’s pressing of the shooting/automatic transfer button 503 on the function selection screen 501. At T907, the communication apparatus 200 displays the shooting/automatic transfer screen 504 on the display unit 206 (as in step S701). At T908, the communication apparatus 200 transitions to a state of standing by for a notification from the image capturing apparatus 100, until a shooting/automatic transfer end operation is accepted from the user (through the determination processing of step S711).

When the chunk recording period timer expires at T909, the image capturing apparatus 100 generates a chunk moving image file at T910. At T911, the image capturing apparatus 100 transmits a moving image file generation notification for the generated moving image file to the communication apparatus 200. At this time, the generated moving image file is an intermediate chunk moving image file, and thus the image capturing apparatus 100 generates a moving image file generation notification indicating that the filename is “MVID0002.MP4”.

At T912, upon receiving the moving image file generation notification, the communication apparatus 200 refers to the moving image filename, and determines that the moving image file is not a starting chunk moving image file (through the determination processing in steps S703 and S704). The communication apparatus 200 determines whether the continuous chunk flag is on (as in step S706), and determines that the continuous chunk flag is not on. Because the continuous chunk flag is off, the communication apparatus 200 determines that the moving image file pertaining to the received generation notification is not to be transferred. The communication apparatus 200 then transitions to a state of standing by for a notification from the image capturing apparatus 100 again (through the determination processing in step S711).

Upon receiving a recording stop operation from the user at T913, the image capturing apparatus 100 stops the period timer for chunk recording at T914. At T915, the image capturing apparatus 100 generates a chunk moving image file. At T916, the image capturing apparatus 100 transmits a generation notification for the generated chunk moving image file to the communication apparatus 200. At this time, the generated moving image file is the ending chunk moving image file, and thus the image capturing apparatus 100 generates a moving image file generation notification indicating that the filename is “MVIE0003.MP4”.

At T917, upon receiving the moving image file generation notification, the communication apparatus 200 refers to the moving image filename, and determines that the moving image file is not a starting chunk moving image file (through the determination processing in steps S703 and S704). Next, the communication apparatus 200 determines whether the continuous chunk flag is on (as in step S706), and determines that the continuous chunk flag is not on. Because the continuous chunk flag is off, the communication apparatus 200 determines that the moving image file pertaining to the received generation notification is not to be transferred. The communication apparatus 200 then transitions to a state of standing by for a notification from the image capturing apparatus 100 again (through the determination processing in step S711).

As described above, even though the starting chunk moving image file has not been obtained after the shooting/automatic transfer function was activated, the communication apparatus 200 can ensure the chunk moving image file is not transferred if an intermediate chunk moving image file or the ending moving image file has been received.

On the other hand, if (new) chunk recording has been started again in the image capturing apparatus 100 while the shooting/automatic transfer function remains activated, the moving image files can be obtained starting with the starting moving image file. Accordingly, the communication apparatus 200 transfers the chunk moving image file (to the server 300).

At T918, the image capturing apparatus 100 starts chunk recording by receiving a recording start operation from the user in a state where chunk recording is set to be performed. At T919, to generate a moving image file divided every predetermined length of time designated by the user, the image capturing apparatus 100 starts a period timer for chunk recording that periodically expires after a user-designated predetermined length of time has passed.

When the chunk recording period timer expires at T920, the image capturing apparatus 100 generates a chunk moving image file at T921. At T922, the image capturing apparatus 100 transmits a moving image file generation notification for the generated proxy moving image file to the communication apparatus 200.

At this time, the generated moving image file is the starting chunk moving image file, and thus the image capturing apparatus 100 generates a moving image file generation notification indicating that the filename is “MVIB0004.MP4”. Although the filename is different from the chunk moving image file “MVIB0001.MP4” generated in T904, the image capturing apparatus 100 sets the type of the chunk moving image file (i.e., the fourth letter) to “B”.

At T923, upon receiving the moving image file generation notification, the communication apparatus 200 refers to the moving image filename, and determines that the moving image file is a starting chunk moving image file (through the determination processing in steps S703 and S704). At T924, the communication apparatus 200 turns the continuous chunk flag on (as in step S705). At T925, the communication apparatus 200 transmits a moving image file obtainment request to the image capturing apparatus 100 (as in step S709), and obtains the moving image file from the image capturing apparatus as a response to the moving image file obtainment request. At T926, the communication apparatus 200 transmits the moving image file obtained from the image capturing apparatus 100 to the server 300 (as in step S710), and transitions to a state of standing by for a notification from the image capturing apparatus 100 again (through the determination processing in step S711). The processing performed during the generation of the intermediate chunk moving image file and the ending chunk moving image file that follows is equivalent to that described in FIGS. 8A and 8B, and will therefore be omitted.

As described above, when a file has been generated in the image capturing apparatus 100, the communication apparatus 200 performs control to obtain that file from the image capturing apparatus, and transfers that file to the server when the file is obtained. At this time, if a chunk moving image file (a divided file) has been generated by the image capturing apparatus 100, the communication apparatus 200 determines the transfer status of the chunk moving image files from the start of the moving image to the divided file prior to that chunk moving image file. Then, whether to obtain the generated chunk moving image file (the divided file) from the image capturing apparatus 100 is controlled in accordance with the transfer status. For example, of a series of chunk moving image files to be combined, the communication apparatus 200 determines whether the transfer has been performed starting with the starting chunk moving image file. If the transfer has not been successfully performed from the starting chunk moving image file, such as when the shooting/automatic transfer function was started after the chunk recording was started in the image capturing apparatus 100, the intermediate and ending chunk transfer files are not transferred. However, even in such a case, if the series of chunk moving image files can be successfully transferred (starting with the starting chunk moving image file) after chunk recording is started, the successive chunk moving image files are transferred.

Doing so makes it possible to prevent chunk moving image file transfers which make it impossible to reconstruct the entire moving image.

The foregoing embodiment describes the continuous chunk flag as a flag indicating whether the transfer has been successfully performed from the starting chunk moving image file. However, the communication apparatus 200 can also use this flag as a flag indicating whether the starting chunk moving image file has been successfully obtained. Furthermore, the communication apparatus 200 may determine whether an intermediate or subsequent chunk moving image file is to be obtained according to whether the flag is on. In other words, if a chunk moving image file (a divided file) has been generated by the image capturing apparatus 100, the communication apparatus 200 can determine the obtainment status of the chunk moving image files from the start of the moving image to the divided file prior to the chunk moving image file to be processed. If a chunk moving image file from the start of the moving image to the divided file prior to the chunk moving image file to be processed has not been obtained, the communication apparatus 200 performs control such that the chunk moving image file to be processed is not obtained from the image capturing apparatus 100. Conversely, if a chunk moving image file from the start of the moving image to the divided file prior to the chunk moving image file to be processed has been obtained, the communication apparatus 200 performs control such that the chunk moving image file to be processed is obtained from the image capturing apparatus 100.

Although the present embodiment describes an example in which whether the intermediate and ending chunk moving image files are to be transferred is determined according to the continuous chunk flag indicating whether the starting chunk moving image file has been transferred, the determination method is not limited thereto. For example, if the filename includes an expression indicating the order of generation, that order may be used. Specifically, the communication apparatus 200 may store filenames previously transferred, and then determine whether the filename for which the next generation notification was received has continuity with the transferred filenames. In this case, the communication apparatus 200 may skip transferring the chunk moving image file when there is no continuity from the previous chunk moving image file.

Furthermore, although the present embodiment describes an example in which the type of the moving image file or the chunk moving image file is determined based on the filename, the determination method is not limited thereto. For example, information indicating the type may be input to a metadata region of the moving image file, and the communication apparatus 200 may determine the type of the moving image file or the chunk moving image file by referring to the metadata region. In this case, the communication apparatus 200 may obtain the moving image file from the image capturing apparatus 100, refer to the metadata region, and control whether to transfer the moving image file to the server 300 in accordance with the type of the chunk moving image file. Alternatively, the communication apparatus 200 may obtain information of the metadata region of the moving image file from the image capturing apparatus 100, and perform processing that refers to the metadata information (without receiving the file itself).

Alternatively, the moving image file generation notification may include a generation time of the starting moving image file and a generation time of the moving image file corresponding to the generation notification. In the starting moving image file generation notification, the generation time of the starting moving image file and the generation time of the moving image file corresponding to the generation notification match. Through this, too, the communication apparatus can determine whether the moving image file is the starting moving image file or another moving image file based on whether the times match, and then make a determination using the type of the chunk moving image file.

The communication apparatus 200 may also obtain the type of the chunk moving image file from the image capturing apparatus 100 by querying the image capturing apparatus 100 for the type of the obtained chunk moving image file using, for example, the filename, an identifier, or the like of the moving image file. Through this, too, the determination can be made using the type of the chunk moving image file.

### Second Embodiment

A second embodiment will be described next. In the foregoing first embodiment, a notification standby state can be entered regardless of whether chunk recording has been started. Then, of the series of chunk moving image files to be combined, the communication apparatus 200 controls the transfer of the intermediate and ending chunk moving image files depending on whether the transfer has been performed starting with the starting chunk moving image file. In the second embodiment, control is performed such that the shooting/automatic transfer function cannot be started unless the chunk recording by the image capturing apparatus 100 is stopped. Although the second embodiment differs from the first embodiment in terms of some of the automatic transfer processing operations in the communication apparatus 200, the configurations of the image capturing apparatus 100 and the communication apparatus 200 are the same as in the first embodiment. As such, configurations that are identical or substantially identical will be given the same reference signs, and redundant descriptions will be omitted.

### Automatic Transfer Processing Operations in Communication Apparatus 200

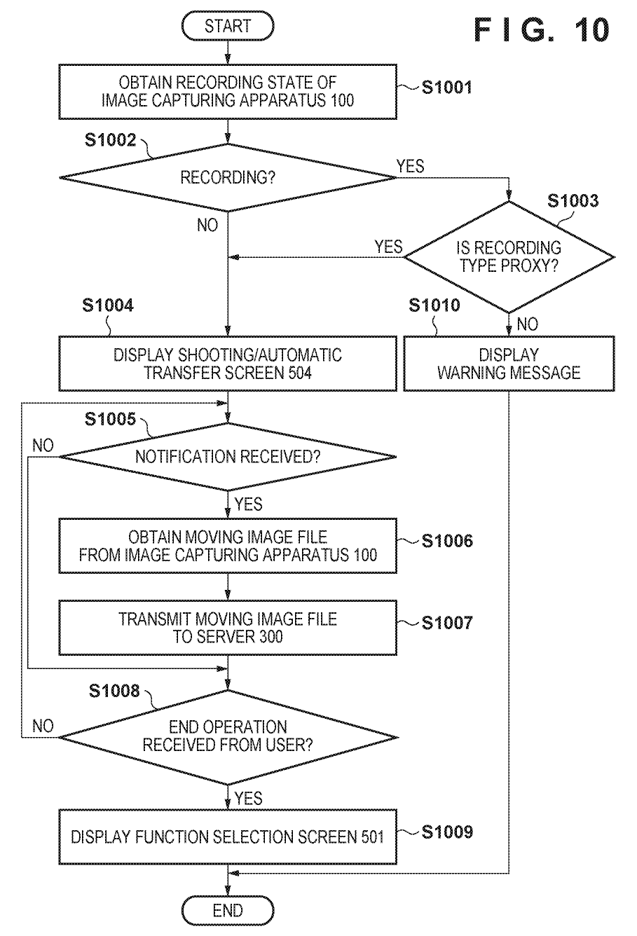

A series of operations in the automatic transfer processing performed by the communication apparatus 200 will be described with reference to FIG. 10. Unless specifically mentioned otherwise, this processing is realized by the control unit 201 loading a program stored in the non-volatile memory 203 into the working memory 204 and executing the program to control the various units of the communication apparatus 200. The series of operations in the automatic transfer processing is started in response to the shooting/automatic transfer button 503 being pressed in the function selection screen 501.

In step S1001, the control unit 201 transmits a recording state obtainment request to the image capturing apparatus 100. The recording state includes information as to whether the image capturing apparatus 100 is currently recording and what kind of recording is being performed. In other words, the recording state indicates that a moving image is being recorded, and whether the moving image being recorded is a proxy moving image or a chunk moving image. For example, the image capturing apparatus 100 responds to the communication apparatus 200 with a recording state of “not recording”, “proxy recording”, or “chunk recording”.

In step S1002, the control unit 201 determines whether the image capturing apparatus 100 is currently recording based on the obtained recording state. The control unit 201 determines that recording is in progress if the recording state of the image capturing apparatus 100 is “proxy recording” or “chunk recording”, and moves the sequence to step S1003. However, if the recording state is “not recording”, the control unit 201 moves the sequence to step S1004.

In step S1003, the control unit 201 determines a recording type from the obtained recording state. The control unit 201 moves the sequence to step S1004 if the recording state is “proxy recording”, and to step S1010 if the recording state is “chunk recording”. In step S1004, the control unit 201 displays the shooting/automatic transfer screen 504.

In step S1005, the control unit 201 moves the sequence to step S1006 if a moving image file generation notification has been received from the image capturing apparatus 100, and moves the sequence to step S1008 if no moving image file generation notification has been received.

In step S1006, the control unit 201 transmits an obtainment request to the image capturing apparatus 100 for the moving image file for which the moving image file generation notification has been received, and obtains the moving image file from the image capturing apparatus as a response to the moving image file obtainment request. In step S1007, the control unit 201 transmits the moving image file obtained from the image capturing apparatus 100 to the server 300.

In step S1008, the control unit 201 determines whether a shooting/automatic transfer end operation has been received by way of the user pressing the back button 505 provided in the shooting/automatic transfer screen 504. In step S1008, if the control unit 201 determines that an end operation has been received, the shooting/automatic transfer function is ended by displaying the function selection screen 501. If the end operation has not been received, the sequence returns to step S1005, where a notification from the image capturing apparatus 100 is received again.

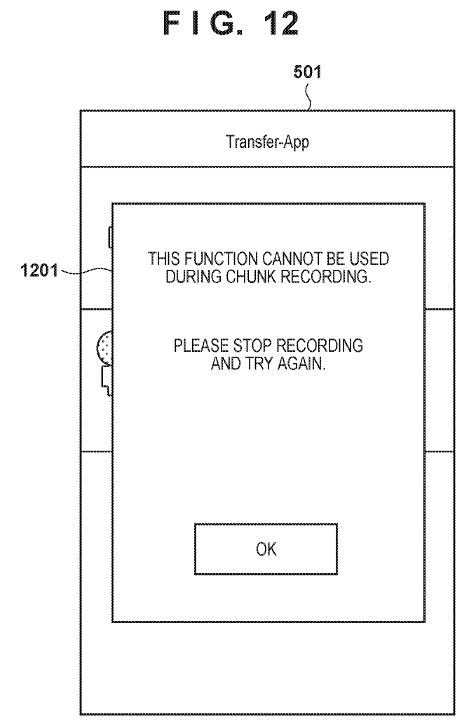

In step S1010, the control unit 201 displays a warning message 1201, such as that illustrated in FIG. 12, indicating that the shooting/automatic transfer function cannot be used during chunk recording. In this manner, the shooting/automatic transfer function cannot be used during chunk recording, which makes it possible to prevent intermediate and subsequent chunk moving image files from being transferred if the previous chunk moving image files that are to be combined have not yet been transferred.

Processing Sequence when Processing in FIG. 10 Is Applied

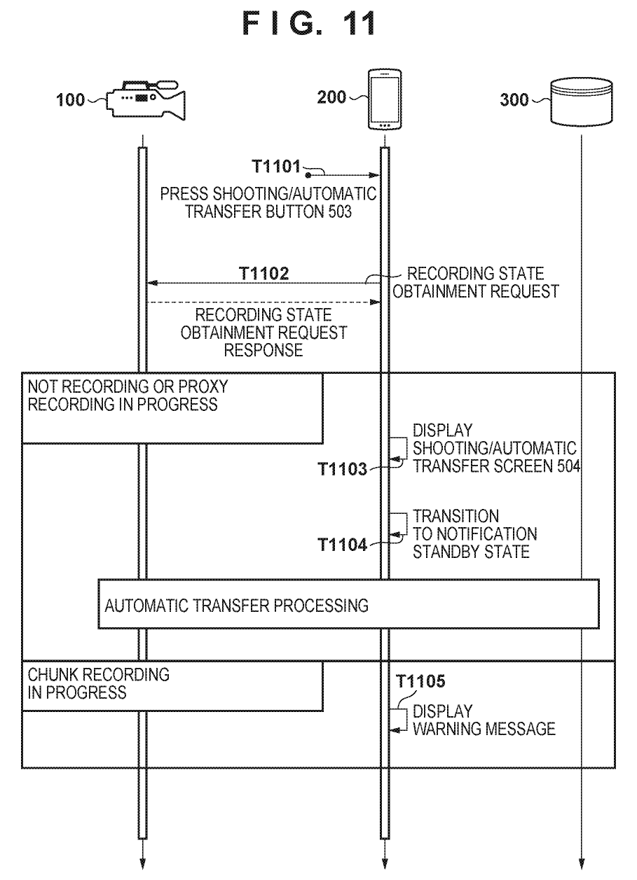

Furthermore, a processing sequence performed among the apparatuses after the user has performed an operation for selecting the shooting/automatic transfer function will be described with reference to FIG. 11.

At T1101, the communication apparatus 200 accepts the user’s pressing of the shooting/automatic transfer button 503 on the function selection screen 501. At T1102, the communication apparatus 200 transmits a recording state obtainment request to the image capturing apparatus 100 (as in step S1001), and obtains the recording state from the image capturing apparatus 100. At T1103, if the recording state is “not recording” or “proxy recording”, the communication apparatus 200 displays the shooting/automatic transfer screen 504 (through the processing of step S1004, in accordance with the determination made in steps S1002 and S1003).

At T1104, the communication apparatus 200 transitions to a state of standing by for a notification from the image capturing apparatus 100, until a shooting/automatic transfer end operation is received from the user (through the determination processing in steps S1005 and S1008). The automatic transfer processing is performed thereafter. For example, if the recording state was “not recording”, the processing indicated in T601 to T606 described above is performed in the case of proxy recording, whereas the processing indicated in T607 to T624 described above is performed in the case of chunk recording. Furthermore, if the recording state was “proxy recording”, the recording has already been started, and thus the processing of T602 to T606 described above is performed.

On the other hand, if the recording state obtained at T1102 is “chunk recording”, the communication apparatus 200 displays the warning message 1201 on the display unit 206 (as in step S1010) at T1105.

Although the present embodiment describes a case where the recording type is obtained from the image capturing apparatus 100 at the timing at which the shooting/automatic transfer function is started as an example, the configuration is not limited thereto. For example, the image capturing apparatus 100 may notify the communication apparatus 200 of the recording type when connecting to the communication apparatus 200, when the recording type is changed, or the like, and the communication apparatus 200 may activate or deactivate the shooting/automatic transfer function when the recording type is received.

As described above, according to the present embodiment, the communication apparatus 200 obtains the recording state of the moving image (a recording state in which continuous time-series data is recorded into a file) in the image capturing apparatus 100. Then, if the obtained recording state is chunk recording (a state in which a divided file is being generated), the communication apparatus 200 disables the shooting/automatic transfer function, and performs control such that the file cannot be obtained from the image capturing apparatus 100. On the other hand, if the recording state is not chunk recording (a state in which a divided file is not being generated), the communication apparatus 200 activates the shooting/automatic transfer function, and performs control such that the file can be obtained from the image capturing apparatus 100.

Doing so makes it possible to prevent the communication apparatus 200 from transferring (to a server or the like) intermediate and subsequent chunk moving image files when the previous chunk moving image files to be combined have not yet been transferred.

According to the present disclosure, when transferring time-series data such as moving image files to an external apparatus, situations where files necessary for combining are missing can be prevented.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A communication apparatus comprising:
a communication unit configured to communicate with an external apparatus;
a control unit configured to, in a case where a file is generated in a first external apparatus, perform control to obtain the file from the first external apparatus via the communication unit; and
a transfer unit configured to, in a case where the file is obtained, transfer the file to a second external apparatus via the communication unit,
wherein in a case where a first divided file is generated in the first external apparatus as a divided file generated in sequence by dividing continuous time-series data, the control unit controls whether to obtain the first divided file from the first external apparatus, in accordance with an obtainment status of a divided file from a start of the time-series data to a divided file prior to the first divided file.

2. The communication apparatus according to claim 1, in a case where the divided file from the start of the time-series data to the divided file prior to the first divided file was not obtained, the control unit does not obtain the first divided file from the first external apparatus.

3. The communication apparatus according to claim 1, in a case where the divided file from the start of the time-series data to the divided file prior to the first divided file was obtained, the control unit obtains the first divided file from the first external apparatus.

4. The communication apparatus according to claim 1, in a case where a second divided file corresponding to the start of the time-series data is generated in the first external apparatus, the control unit obtains the second divided file from the first external apparatus.

5. The communication apparatus according to claim 1, in a case where a file including an entirety of the time-series data is generated in the first external apparatus, the control unit obtains the file including the entirety of the time-series data from the first external apparatus.

6. The communication apparatus according to claim 1, the control unit obtains, from the first external apparatus, a generation notification indicating that the file was generated, and identifies whether the generated file is the first divided file or a second divided file corresponding to the start of the time-series data based on information included in the generation notification.

7. The communication apparatus according to claim 1, in a case where the file is generated in the first external apparatus, the control unit identifies whether the generated file is the first divided file or a second divided file corresponding to the start of the time-series data in accordance with a filename of the file obtained from the first external apparatus.

8. The communication apparatus according to claim 1, in a case where the file is generated in the first external apparatus, the control unit obtains metadata of the file, and identifies whether the generated file is the first divided file or a second divided file corresponding to the start of the time-series data in accordance with the obtained metadata.

9. A communication apparatus comprising:
a communication unit configured to communicate with an external apparatus;
an obtaining unit configured to obtain, via the communication unit, a recording state of recording into a file of continuous time-series data in a first external apparatus;
a control unit configured to, in a case where a file is generated in a first external apparatus, perform control to obtain the file from the first external apparatus via the communication unit; and
a transfer unit configured to, in a case where the file is obtained, transfer the file to a second external apparatus via the communication unit,
wherein in a case where the recording state obtained by the obtaining unit is a state in which a divided file, which is recorded by dividing the continuous time-series data, is being generated, the control unit performs control to prevent the file from being obtained from the first external apparatus, and in a case where the recording state is not the state in which the divided file is being generated, the control unit performs control to enable the file to be obtained from the first external apparatus.

10. A method for controlling a communication apparatus, the communication apparatus including communication device configured to communicate with an external apparatus, the method comprising:
in a case where a file is generated in a first external apparatus, performing control to obtain the file from the first external apparatus via the communication device; and
in a case where the file is obtained, transferring the file to a second external apparatus via the communication device,
wherein in a case where a first divided file is generated in the first external apparatus as a divided file generated in sequence by dividing continuous time-series data, in the controlling, whether to obtain the first divided file from the first external apparatus is controlled in accordance with an obtainment status of a divided file from a start of the time-series data to a divided file prior to the first divided file.

11. A method for controlling a communication apparatus, the communication apparatus including communication device to communicate with an external apparatus, the method comprising:
obtaining, via the communication device, a recording state of recording into a file of continuous time-series data in a first external apparatus;
in a case where a file is generated in a first external apparatus, performing control to obtain the file from the first external apparatus via the communication device; and
in a case where the file is obtained, transferring the file to a second external apparatus via the communication device,
wherein in the controlling, in a case where the recording state obtained in the obtaining is a state in which a divided file, which is recorded by dividing the continuous time-series data, is being generated, control is performed to prevent the file from being obtained from the first external apparatus, and in a case where the recording state is not the state in which the divided file is being generated, control is performed to enable the file to be obtained from the first external apparatus.

12. A non-transitory computer readable storage medium storing a program for causing a computer to perform a method for controlling a communication apparatus with a communication device, the method comprising:
in a case where a file is generated in a first external apparatus, performing control to obtain the file from the first external apparatus via the communication device; and
in a case where the file is obtained, transferring the file to a second external apparatus via the communication device,
wherein in a case where a first divided file is generated in the first external apparatus as a divided file generated in sequence by dividing continuous time-series data, in the controlling, whether to obtain the first divided file from the first external apparatus is controlled in accordance with an obtainment status of a divided file from a start of the time-series data to a divided file prior to the first divided file.
